(19) United States
(12) Patent Application Publication
(10) Pub. No.: US 2018/0250871 A1
(43) Pub. Date: Sep. 6, 2018

(54) THREE-DIMENSIONAL BUILDING APPARATUS AND THREE-DIMENSIONAL BUILDING METHOD

(71) Applicant: MIMAKI ENGINEERING CO., LTD., Nagano (JP)

(72) Inventors: Hikaru Mugishima, Nagano (JP); Kazuhiro Ochi, Nagano (JP)

(73) Assignee: MIMAKI ENGINEERING CO., LTD., NAGANO (JP)

(21) Appl. No.: 15/905,832

(22) Filed: Feb. 27, 2018

(30) Foreign Application Priority Data
Mar. 1, 2017 (JP) 2017-038648

(51) Int. Cl. B29C 64/112; B29C 64/295; B29C 64/218; B29C 64/40; B33Y 10/00; B33Y 30/00

(52) U.S. Cl. CPC B29C 64/112; B29C 64/295; B33Y 30/00; B29C 64/40; B33Y 10/00; B29C 64/218

(57) ABSTRACT

To provide a three-dimensional building apparatus and a three-dimensional building method capable of generating a three-dimensional object with sufficient adhesion between unit layers even when a photocurable material having larger cure shrinkage due to photocuring placed under a low temperature condition is used as a model material and a support material. A three-dimensional building apparatus includes: a stage configured to hold a deposition structure formed by depositing unit layers; an ejector configured to eject a photocurable model material and a photocurable support material toward the uppermost surface of the deposition structure while moving relative to the stage; an emitter configured to emit an active beam light capable of curing the photocurable model material and the photocurable support material; and a heater configured to heat the uppermost surface of the deposition structure in forming a workpiece.

### CROSS REFERENCE TO RELATED APPLICATIONS

This application claims the priority benefit of Japanese Patent Application No. 2017-038648, filed on Mar. 1, 2017. The entirety of the above-mentioned patent application is hereby incorporated by reference herein and made a part of this specification.

### TECHNICAL FIELD

The present disclosure relates to a three-dimensional building apparatus and a three-dimensional building method for generating a three-dimensional object formed of a photocurable model material, by removing a support member formed of a photocurable support material from a workpiece obtained by successively depositing unit layers including the model material and/or the support material.

### BACKGROUND ART

Three-dimensional building apparatuses (called 3D printers) have recently been developed, which generate an object having a three-dimensional shape by successively depositing layers in units of slices (hereinafter referred to as unit layers) along the vertical direction while solidifying the layers. A three-dimensional object formed of a model material is generated typically by removing a support member formed of a support material from a workpiece obtained by successively depositing unit layers including the model material and/or the support material.

When a three-dimensional object is built directly on a work surface of a stage, the bottom surface of the workpiece may be deformed when removed from the stage, resulting in deterioration of quality of the three-dimensional object. Specifically, the surface shape of the work surface may be transferred to the bottom surface, or the bottom surface sticking to the work surface may be partially lost. In order to avoid such phenomena, a pedestal made of a support material that can be removed later may be disposed between the bottom surface and the work surface.

Meanwhile, the unit layers may interfere with each other due to differences in building conditions of the three-dimensional object, and the curing properties may vary to a non-negligible degree. In particular, differences in curing properties between the materials may cause distortion in the vicinity of the contact surface between the body of the object and the pedestal, and the adhesion of the body to the pedestal is likely to be reduced. As a result, separation between the body and the pedestal may occur during the course of formation of the workpiece, thereby reducing the reproducibility of the building position on the upper layer side.

U.S. Pat. No. 8,636,494 (see, for example, FIG. 3A, FIG. 4B, and FIG. 4C) proposes an apparatus that includes a heater (heating element) at a stage for heating from below a workpiece. According to the description, merging of different materials at the interface line is thus reduced, and the adhesion of the body to the pedestal is kept.

Patent Literature: U.S. Pat. No. 8,636,494

### SUMMARY

In a case of using a photocurable material as a model material and a support material, occurrence of cure shrinkage can particularly be a problem. For example, depending on the kind of photocurable materials, photocuring placed under a low temperature condition may cause cure shrinkage to become large and distortion between unit layers may readily occur.

However, the device proposed in U.S. Pat. No. 8,636,494 employs the configuration where layers are heated from a lower layer side, and it takes a long time to heat the uppermost layer, which is recently formed, or the vicinity thereof. As a result, an uppermost surface cannot be sufficiently heated until the uppermost surface is completely cured, and an effect of maintaining the adhesion between unit layers cannot be obtained as expected.

The present disclosure is made in view of the problem above and provides a three-dimensional building apparatus and a three-dimensional building method capable of generating a three-dimensional object with sufficient adhesion between unit layers even when a photocurable material having larger cure shrinkage due to photocuring placed under a low temperature condition is used as a model material and a support material.

A “three-dimensional building apparatus” according to the present disclosure generates a three-dimensional object formed of a photocurable model material, by removing a support member formed of a photocurable support material from a workpiece obtained by successively depositing unit layers including the photocurable model material and/or the photocurable support material. The three-dimensional building apparatus includes: a stage, configured to hold a deposition structure formed by depositing the unit layers; an ejector, configured to eject the photocurable model material and the photocurable support material toward an uppermost surface of the deposition structure while moving relative to the stage; an emitter, configured to emit an active beam light capable of curing the photocurable model material and the photocurable support material; and a heater, configured to heat the uppermost surface of the deposition structure in forming the workpiece.

In this manner, the three-dimensional building apparatus is provided with the emitter for emitting active beam light capable of curing a photocurable model material and a photocurable support material and the heater for heating the uppermost surface of the deposition structure in forming the workpiece so as to directly and effectively heat the uppermost surface that is before being completely cured by emission of the active beam light. Thus, a three-dimensional object with sufficient adhesion between unit layers can be generated even when a photocurable material having larger cure shrinkage due to photocuring placed under a low temperature condition is used as a model material and a support material.

In an embodiment, the support member that is part of the workpiece includes a pedestal disposed between the three-dimensional object and the stage. Differences in curing properties between the model material and the support material may cause distortion in the vicinity of the contact surface between the body of the three-dimensional object and the pedestal, and the adhesion of the body to the pedestal is likely to be reduced. Accordingly, the adhesion improvement effect described above is more significant.

In an embodiment, the heater sequentially heats the uppermost surface on which ejection by the ejector and emission by the emitter are repeatedly performed. The adhesion between all of the unit layers can be maintained by repeatedly executing an operation unit including ejection, heating, and emission.

In an embodiment, the three-dimensional building apparatus further includes a heating controller that controls a temperature of the heater, so that the workpiece is heated at a higher temperature on a lower layer side, and the workpiece is heated at a lower temperature on an upper layer side. The shearing stress acting between the unit layers of the workpiece tends to increase on the lower layer side and decrease on the upper layer side. Energy saving of building process can be achieved by reducing thermal energy at the upper layer side where unit layers are hardly peeled off in relative terms.

In an embodiment, the heater is integrally with the ejector and is movable relative to the stage, and the three-dimensional building apparatus further includes a heating controller configured to control a temperature of the heater, so that a heating is temporarily prevented or stopped during the heater is at a position where the heater is unable to heat the uppermost surface. In this manner, supplying thermal energy can be prevented at a position that does not contribute to heating of the uppermost surface, and energy saving of building process can be achieved.

In an embodiment, the heater is a warm air jetting part that jets a warm air toward the uppermost surface. Jetting warm air enables contactless heating, so that the uppermost surface is not roughened.

In an embodiment, the three-dimensional building apparatus further includes a planarizing roller configured to contact the uppermost surface while moving relative to the stage so as to planarize the uppermost surface, and the heater is the planarizing roller heated by a built-in heater. In this manner, the uppermost surface can be planarized and heated at the same time.

A “three-dimensional building method” according to the present disclosure is a method in which a three-dimensional object formed of a photocurable model material is generated by removing a support member formed of a photocurable support material from a workpiece obtained by successively depositing unit layers including the photocurable model material and/or the photocurable support material. The three-dimensional building method includes: an ejecting step of ejecting the photocurable model material and the photocurable support material toward an uppermost surface of a deposition structure formed by depositing the unit layers, while moving relative to a stage configured to hold the layered structure; an emitting step of emitting an active beam light capable of curing the photocurable model material and the photocurable support material, and a heating step of heating the uppermost surface of the deposition structure in forming the workpiece.

The three-dimensional building apparatus and the three-dimensional building method according to the present disclosure can generate a three-dimensional object with sufficient adhesion between unit layers even when a photocurable material having larger cure shrinkage due to photocuring placed under a low temperature condition is used as a model material and a support material.

### BRIEF DESCRIPTION OF THE DRAWINGS

FIGS. 1A and 1B are schematic diagrams illustrating the main part of a three-dimensional building apparatus according to a first embodiment.

FIG. 2 is an electrical block diagram of the three-dimensional building apparatus illustrated in FIGS. 1A and 1B.

FIGS. 3A and 3B are diagrams illustrating a mode of a three-dimensional object and a workpiece.

FIG. 4 is a flowchart for explaining the operation of the three-dimensional building apparatus illustrated in FIGS. 1A and 1B and FIG. 2.

FIGS. 5A and 5B are partially enlarged cross-sectional views of the workpiece in the vicinity of a contact surface between a body and a pedestal.

FIGS. 6A and 6B are schematic diagrams related to a method for controlling temperature of a heating unit.

FIGS. 7A and 7B are schematic diagrams illustrating the principal part of a three-dimensional building apparatus according to a second embodiment.

FIGS. 8A and 8B are schematic diagrams illustrating the principal part of a three-dimensional building apparatus according to a third embodiment.

### DESCRIPTION OF EMBODIMENTS

A three-dimensional building apparatus according to the present disclosure will be described below, with suitable embodiments in relation to a three-dimensional building method, with reference to the accompanying drawings.

### First Embodiment

<Configuration of Main Part of Three-Dimensional Building Apparatus 10>

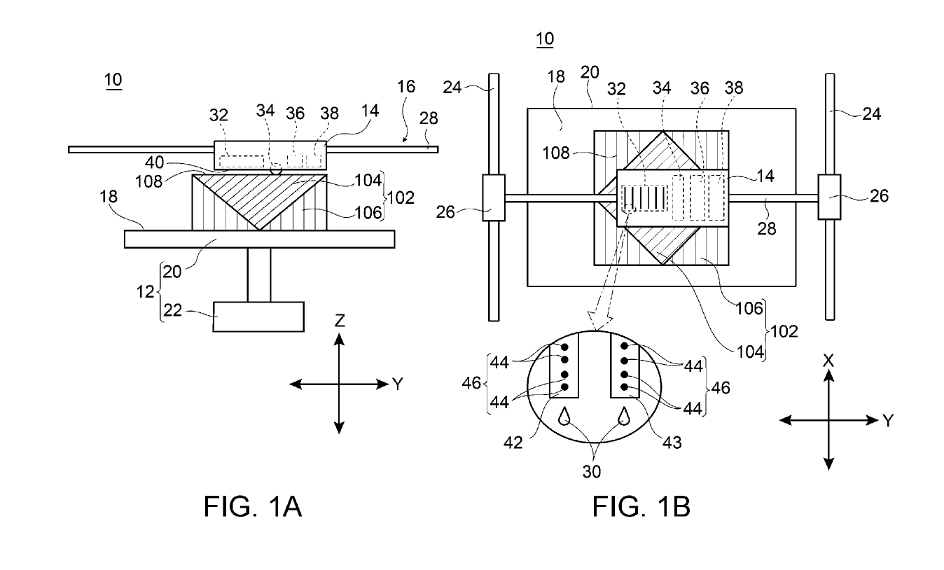

FIGS. 1A and 1B are schematic diagrams illustrating the main part of a three-dimensional building apparatus 10 according to a first embodiment. More specifically, FIG. 1A is a schematic side view of the three-dimensional building apparatus 10, and FIG. 1B is a schematic plan view of the three-dimensional building apparatus 10. The figures depict a deposition structure 102 that is a three-dimensional object 100 in the process of production.

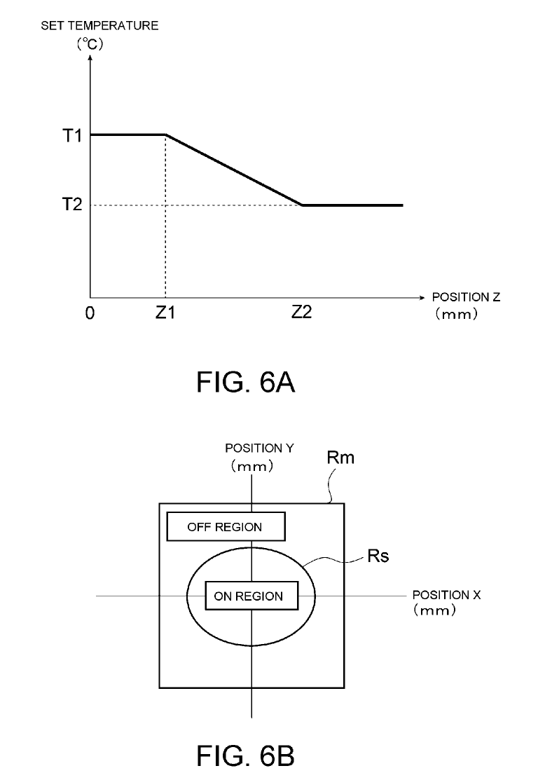

The deposition structure 102 is formed with a model material 104 that is a raw material of the three-dimensional object 100 and a support material 106 that supports the model material 104 from the outside or the inside. More specifically, the deposition structure 102 is formed by successively depositing unit layers 131 to 134 (see FIG. 6) including the model material 104 and/or the support material 106 along the vertical direction.

The three-dimensional building apparatus 10 includes a stage unit 12 on which the deposition structure 102 is placed, a carriage 14 in which an ejection mechanism for the model material 104 and the support material 106 is installed, and a carriage driver 16 that drives the carriage 14 in the X direction and the Y direction.

The stage unit 12 includes a stage 20 having a flat work surface 18 and a stage driver 22 that moves the stage 20 in a direction (the Z direction) normal to the work surface 18. The carriage driver 16 includes a pair of guide rails 24 and 24 (X bars) extending parallel to the X direction, two sliders 26 and 26 movable along the respective guide rails 24, and a carriage rail 28 (Y bar) running between the two sliders 26 and 26 and extending in the Y direction.

The carriage 14 is movable along the carriage rail 28 having the carriage 14 attached thereto or along the guide rails 24 and 24 integrally with the carriage rail 28. The carriage 14 and the stage 20 are thus movable relative to the X direction, the Y direction, and the Z direction orthogonal to each other. In the present embodiment, the X direction and the Y direction agree with the “horizontal direction”, the Z direction agrees with the “vertical direction”, and the three directions are orthogonal to each other.

In the carriage 14, an ejection unit 32 (an ejector) that ejects a flowable model material 104 and a flowable support material 106 (which hereinafter may be collectively referred to as “droplets 30”) toward an uppermost surface 108 of the deposition structure 102, a planarizing roller 34 (a planarizer) that planarizes the uppermost surface 108, a heating unit 36 (a heater) that heats the uppermost surface 108, and an emitting unit 38 (an emitter) that emits active beam light toward the uppermost surface 108 are installed.

The ejection unit 32 has an ejection surface 40 located to be opposed to the work surface 18 or the uppermost surface 108. The ejection unit 32 includes a plurality of ejection heads 42 that eject the model material 104 of the same or different colors and one ejection head 43 that ejects the support material 106. A variety of methods may be employed as a mechanism for ejecting droplets 30 with the ejection heads 42 and 43. For example, a method of ejecting droplets 30 through deformation of an actuator including a piezoelectric element may be employed. Alternatively, a method of ejecting droplets 30 with pressure caused by bubbles produced by heating the model material 104 or the support material 106 with a heater (heating element) may be employed.

The ejection heads 42 and 43 each have a nozzle row 46 having a plurality of nozzles 44 arranged in a row along the arrangement direction (in the example in the figures, the X direction) on the ejection surface 40 side. When the ejection unit 32 includes six ejection heads 42, for example, the six ejection heads 42 eject droplets 30 of the model material 104 colored in cyan (C), magenta (M), yellow (Y), black (K), clear (CL), and white (W).

The heating unit 36 includes, for example, a warm air jetting part that jets warm air, and is a contactless heater capable of supplying thermal energy through jetting of warm air. This heating unit 36 heats, before the droplets 30 are completely cured, the uppermost surface 108 so that a temperature range is suitable (for example, 50° C. or more).

When the model material 104 and the support material 106 are an ultra-violet (UV) curable resin, the emitting unit 38 includes a UV light source emitting UV that is one form of active beam light. A rare gas discharge lamp, a mercury discharge lamp, a fluorescent lamp, and a light emitting diode (LED) array, and the like may be used as the UV light source. The support material 106 is made of a material that can be removed without altering the three-dimensional object 100, such as water swelling gel, wax, thermoplastic resin, water-soluble material, and soluble material.

<Electrical Block Diagram of the Three-Dimensional Building Apparatus 10>

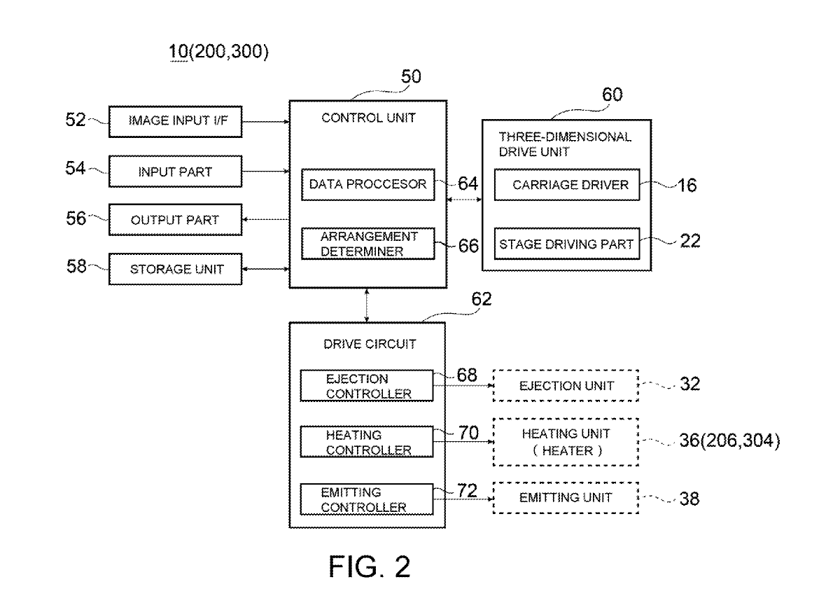

FIG. 2 is an electrical block diagram of the three-dimensional building apparatus 10 illustrated in FIGS. 1A and 1B. The three-dimensional building apparatus 10 includes, in addition to the carriage driver 16, the stage driver 22, the ejection unit 32, the heating unit 36, and the emitting unit 38 illustrated in FIGS. 1A and 1B, a control unit 50, an image input interface (I/F) 52, an input unit 54, an output unit 56, a storage unit 58, a three-dimensional drive unit 60, and a drive circuit 62.

The image input I/F 52 is configured with a serial I/F or a parallel I/F and receives an electrical signal including image information representing a three-dimensional object 100 from a not-illustrated external device. The input unit 54 includes a mouse, a keyboard, a touch sensor, or a microphone. The output unit 56 includes a display or a speaker.

The storage unit 58 is configured with a non-transitory and computer-readable recording medium. Here, the computer-readable recording medium is a portable medium such as optical magnetic disc, ROM, CD-ROM, or flash memory, or a storage device such as hard disk contained in a computer system. The recording medium may be the one that retains a program dynamically for a short time or the one that retains a program for a certain time.

The three-dimensional drive unit 60 drives at least one of the stage 20 and the ejection unit 32 to move the ejection unit 32 relative to the stage 20 in three-dimensional directions. In the present embodiment, the three-dimensional drive unit 60 includes the carriage driver 16 that moves the ejection unit 32 in the X direction and the Y direction and the stage driver 22 that moves the stage 20 in the Z direction.

The control unit 50 is an arithmetic unit that controls the components included in the three-dimensional building apparatus 10 and is configured with, for example, a central processing unit (CPU), or a micro-processing unit (MPU). The control unit 50 can read and execute a program stored in the storage unit 58 to implement the functions including a data processor 64 and an arrangement determiner 66.

The drive circuit 62 is an electric circuit that is electrically connected to the control unit 50 and drives each unit for executing a building process. In the present embodiment, the drive circuit 62 includes an ejection controller 68 that controls ejection of the ejection unit 32 and a heating controller 70 that controls heating of the heating unit 36 and an emitting controller 72 that controls emission of the emitting unit 38.

The ejection controller 68 generates a drive waveform signal for actuators included in the ejection heads 42 and 43, based on ejection data supplied from the control unit 50, and outputs this waveform signal to the ejection unit 32. The heating controller 70 outputs a drive signal corresponding to the temperature or the jetting amount of warm air to the heating unit 36. The emitting controller 72 outputs a drive signal corresponding to the radiation amount of ultraviolet rays to the emitting unit 38.

<Mode of Three-Dimensional Object 100 and Workpiece 120>

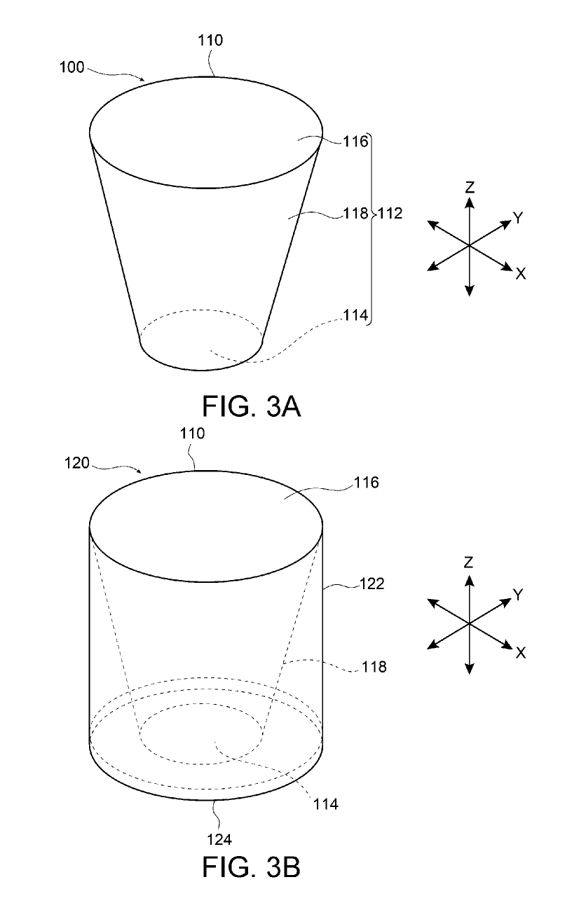

FIGS. 3A and 3B are diagrams illustrating a mode of the three-dimensional object 100 and the workpiece 120. More specifically, FIG. 3A is a front view of the three-dimensional object 100, and FIG. 3B is a front view of the workpiece 120. The workpiece 120 corresponds to a finished state of the deposition structure 102 and is an object from which the support material 106 (support member 122) has not yet been removed.

As illustrated in FIG. 3A, the three-dimensional object 100 formed of the model material 104 has an inverse truncated cone-shaped body 110. An outer surface 112 of the body 110 includes a circular bottom surface 114, an upper surface 116 having a diameter smaller than the bottom surface 114, and a side surface 118 coupling the bottom surface 114 with the upper surface 116.

The body 110 is made of a material that cures through a physical process or a chemical process, here, a UV curable resin. Examples of the UV curable resin include radical polymerization-type resins that cure through a radical polymerization reaction and cation polymerization-type resins that cure through a cationic polymerization reaction. Examples of the radical polymerization-type UV curable resins include urethane acrylates, acrylic acrylates, and epoxy acrylates.

As illustrated in FIG. 3B, the workpiece 120 includes the body 110 described above and the support member 122 that supports the body 110 from the outside. The support member 122 approximately has a pot-like shape that covers the entire outer surface 112 excluding the upper surface 116. It should be noted that the support member 122 includes a pedestal 124 disposed between the three-dimensional object 100 and the stage 20 (FIGS. 1A and 1B). The support member 122 is formed of a material that is UV curable as described above and can be removed without altering the three-dimensional object 100.

<Operation of Three-Dimensional Building Apparatus 10>

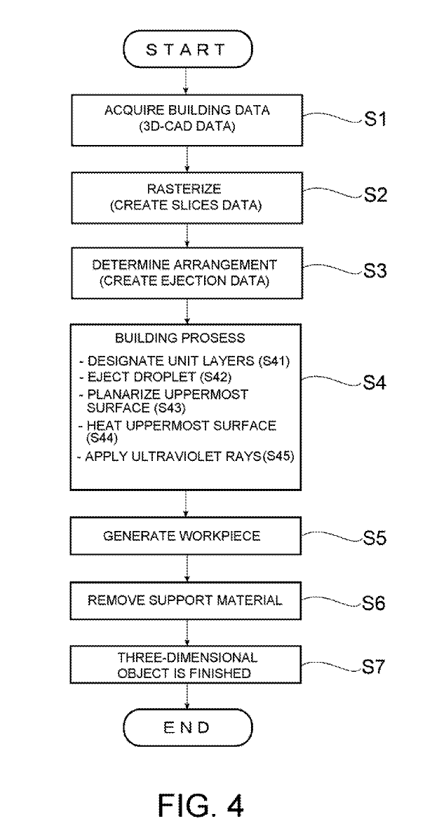

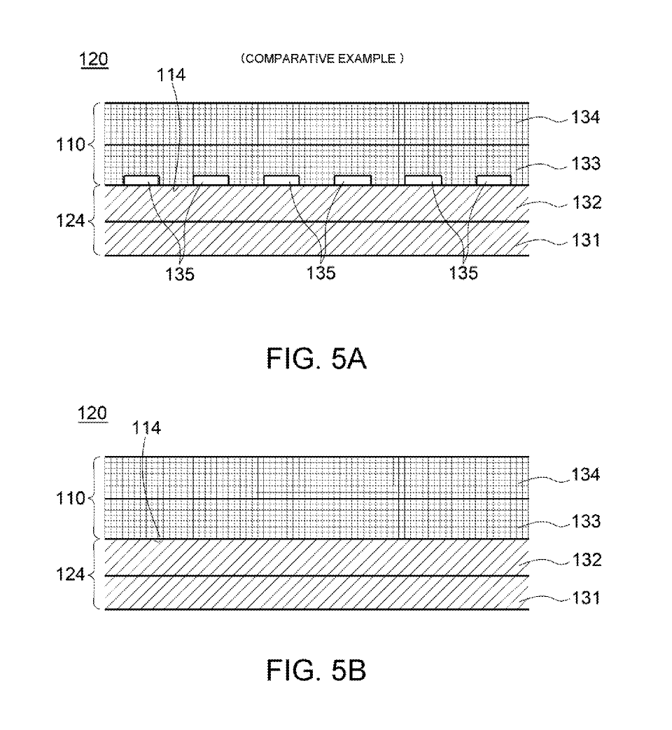

In the operation of the three-dimensional building apparatus 10 illustrated in FIGS. 1A and 1B and FIG. 2, the operation of generating the three-dimensional object 100 illustrated in FIG. 3A will now be described here with reference to the flowchart in FIG. 4, the diagrams in FIGS. 5A and 5B, and the diagrams in FIGS. 6A and 6B, as necessary.

In step S1 in FIG. 4, the control unit 50 acquires building data including 3D-computer aided design (CAD) data through the image input I/F 52. For example, the building data of a wire-frame model is composed of a combination of shape model data representing a three-dimensional frame of the three-dimensional object 100 and surface image data representing the image of the outer surface 112. The representation format of building data is not limited to a wire-frame model but may be a surface model or a solid model.

In step S2, the data processor 64 rasterizes the building data in vector graphics form acquired in step S1. Prior to this processing, the data processor 64 defines a work area representing a three-dimensional space in the X direction, the Y direction, and the Z direction and also determines three-dimensional resolutions (associates with the real size) of the X axis, the Y axis, and the Z axis of the work area 130.

Subsequently, the data processor 64 specifies the color in the frame (for example, white) and arranges the surface image on the frame surface using a known texture mapping technique. The data processor 64 thereafter converts the vector data with the surface image into raster data in accordance with the three-dimensional resolutions. The data processor 64 further executes a variety of image processing such as halftone processing including dithering and error diffusion, separation processing between similar colors/different colors, allocation processing of dot size (the amount of droplets), and processing of controlling the number of droplets. Individual slice data (hereinafter “slices data”) of unit layers 131 to 134 along one direction (the Z axis) is thus obtained.

In step S3, the arrangement determiner 66 determines the arrangement of the model material 104 and the support material 106 using the slices data obtained in step S2. Specifically, the arrangement determiner 66 arranges the support material 106 at a position where the model material 104 can be physically supported in the process of generating the workpiece 120. Through this arrangement process, “ejection data” is created, which indicates the presence/absence and the kind of droplets 30 at each three-dimensional position.

In the example illustrated in FIG. 3A, an outer wall (hereinafter referred to as overhang) protruding like a roof is formed on the side surface 118 of the body 110. When unit layers 131 to 134 are deposited layer by layer from the lower side to the upper side in the vertical direction to build an overhang, the model material 104 protruding outward falls under its own weight due to lack of physical strength for keeping the shape. It is then necessary to arrange the support material 106 between the work surface 18 and the side surface 118 for reinforcing and supporting each part of the side surface 118 from the lower side.

If the three-dimensional object 100 is directly built on the work surface 18, the bottom surface 114 of the body 110 may be deformed when the workpiece 120 is removed from the stage 20, resulting in deterioration of quality of the three-dimensional object 100. Specifically, the surface shape of the work surface 18 may be transferred to the bottom surface 114, or the bottom surface 114 sticking to the work surface 18 may be partially lost. It is then necessary to arrange the pedestal 124 made of the support material 106 that can be removed later, between the bottom surface 114 and the work surface 18.

In step S4, the three-dimensional building apparatus 10 executes a building process based on the ejection data created in step S3. Specifically, the three-dimensional building apparatus 10 generates the deposition structure 102 by successively depositing unit layers 131 to 134 including the model material 104 and the support material 106 along the Z direction while relatively moving the stage 20 and the ejection unit 32 in three-dimensional directions.

Here, [1] designation of the unit layers 131 to 134 to be formed (S41), [2] ejection of droplets 30 using the ejection unit 32 (S42), [3] planarization of the uppermost surface 108 using the planarizing roller 34 (S43), [4] heating the uppermost surface 108 using the heating unit 36 (S44), and [5] emitting UV using the emitting unit 38 (S45) are successively executed. The deposition structure 102 thus grows gradually along the vertical direction (the Z direction).

The droplets 30 on the uppermost surface 108 have a high temperature just after landing on the uppermost surface 108, but are rapidly cooled by contact with the outside air. Depending on the building conditions formed by combining the kind of the model material 104 and the support material 106, an emitting amount and an emitting timing of UV, and the like, cure shrinkage may be large due to photocuring placed under a low temperature condition. As a result, the adhesion between the deposited unit layers 131 to 134 is reduced.

The building process according to the embodiment has a technical feature in which a heating step of the uppermost surface 108 (S44) is executed before an emitting step of UV (S45) is executed. The following describes an effect obtained by this heating step with reference to FIGS. 5A and 5B.

FIGS. 5A and 5B are partially enlarged cross-sectional views of the workpiece 120 in the vicinity of a contact surface between the body 110 and the pedestal 124. More specifically, FIG. 5A is a partially enlarged cross-sectional view of the workpiece 120 obtained by building process that does not include the heating step, and FIG. 5B is a partially enlarged cross-sectional view of the workpiece 120 obtained by building process that includes the heating step.

As illustrated in FIG. 5A, in the vicinity of the contact surface (that is, the bottom surface 114), [1] a unit layer 131 of support material 106, [2] a unit layer 132 of support material 106, [3] a unit layer 133 of model material 104, and [4] a unit layer 134 of model material 104 are successively deposited. In this drawing, a plurality of gaps 135 are produced between the two unit layers 132 and 133. The reason for this is that the difference in curing properties between the model material 104 and the support material 106 causes distortion between the unit layers 132 and 133.

Subsequently, with the adhesion between the unit layers 132 and 133 kept low, large shearing stress acts on the vicinity of the contact surface due to the weight of the workpiece 120 gradually growing. Then, if the unit layers 132 and 133 become separated, the reproducibility of the building position on the upper layer side is degraded, and the workpiece 120 having a desired three-dimensional shape may not be obtained.

By contrast, in FIG. 5B, no gap is produced between the layers of the unit layers 131 to 134. This is because occurrence of cure shrinkage resulting from temperature of the uppermost surface 108 is suppressed by preliminarily heating the unit layers 131 to 134 before emission of UV. Since the adhesion between the unit layers 131 to 134 is kept, separation of the unit layers 131 to 134 with the growth of the workpiece 120 can be prevented. As a result, the reproducibility of the building position is kept throughout the layers, and the workpiece 120 having a desired three-dimensional shape can be obtained.

In principle, it is preferable to make temperature of the uppermost surface 108 higher in order to surely obtain the above-mentioned effect. However, as supplied thermal energy increases, an amount of power consumption for driving the heating unit 36 increases correspondingly. Thus, energy saving of building process can be achieved by devising a method for controlling temperature of the heating unit 36.

FIGS. 6A and 6B are schematic diagrams related to a method for controlling temperature of the heating unit 36. More specifically, FIG. 6A is a graph illustrating position dependency of the set temperature T, and FIG. 6B is a graph illustrating position dependency of ON/OFF control.

The lateral axis of the graph illustrated in FIG. 6A represents a position in the Z direction (unit: mm), and the vertical axis of the graph represents the set temperature T (unit: ° C.). In FIG. 6A, a position of the work surface 18 is defined as a reference point, and a deposition direction of the unit layers 131 to 134 is defined as a positive direction. When 0≤Z≤Z1, the set temperature T is T=T1. When Z≥Z2, the set temperature T is T=T2(<T1). When Z1<Z<Z2, the set temperature T is T=T1+(T2−T1) (Z−Z1)/(Z2−Z1).

In other words, the heating controller 70 may control temperature of the heating unit 36 so that the workpiece 120 is heated at a higher temperature toward on a lower layer side and the workpiece 120 is heated at a lower temperature on an upper layer side. The shearing stress acting between the unit layers 131 to 134 tends to increase on the lower layer side of the workpiece 120 and decrease on the upper layer side. Energy saving of building process can be achieved by reducing thermal energy at an upper layer side where the unit layers 131 to 134 are hardly peeled off in relative terms.

The lateral axis of the graph illustrated in FIG. 6B represents a position in the X direction (unit: mm), and the vertical axis of the graph represents a position in the Y direction (unit: mm). A region surrounded with a square represents a shapable region Rm indicating a space range where the droplets 30 can be ejected. A region surrounded with a circle represents an uppermost surface region Rs indicating a region of the uppermost surface 108 of the deposition structure 102.

When a heating target position of the heating unit 36 is in the uppermost surface region Rs, the heating controller 70 controls temperature so that the heating turns “ON”. By contrast, when a heating target position of the heating unit 36 is in a difference set region (Rm−Rs), the heating controller 70 controls temperature so that the heating turns “OFF”. Examples of a case where the heating turns “OFF” include not only a case where jetting of warm air is stopped but also a form of control where heating can be temporarily reduced (for example, control for reducing the set temperature T or a jetting amount).

In other words, when the heating unit 36 is movable relative to the stage 20 integrally with the ejection unit 32, the heating controller 70 controls temperature so that the heating is performed if the heating unit 36 is at a position (ON region) where the heating unit 36 can heat the uppermost surface 108. By contrast, the heating controller 70 may control temperature so that the heating is temporarily reduced or stopped if the heating unit 36 is at a position (OFF region) where the heating unit 36 cannot heat the uppermost surface 108. In this manner, supplying thermal energy can be reduced at a position that does not contribute to heating of the uppermost surface 108, and energy saving of building process can be achieved.

The building process of the workpiece 120 is thus finished (step S4). When the support member 122 includes the pedestal 124, the adhesion improvement effect is more significant. This is because the adhesion of the body 110 to the pedestal 124 tends to decrease due to the difference in curing properties between the model material 104 and the support material 106.

Along with repetitive movement of the carriage 14 in the Y direction, the heating unit 36 may sequentially heat the uppermost surface 108 on which ejection by the ejection unit 32 and emission by the emitting unit 38 are repeated. The adhesion between all of the unit layers 131 to 134 can be maintained by repeatedly executing an operation unit including ejecting, heating, and emitting.

In step S5 in FIG. 4, the workpiece 120 with the deposition structure 102 in a finished state is obtained (see FIG. 3B). Here, it should be noted that the workpiece 120 has a desired three-dimensional shape, in which the reproducibility of the building position is kept throughout the layers.

In step S6, the workpiece 120 obtained in the step S6 is subjected to the process of removing the support material 106 (support member 122). This removing process can be implemented through a physical process or a chemical process according to the properties of the support material 106, specifically, by dissolution in water, heating, chemical reaction, pressure washing, or electromagnetic radiation.

In step S7, the three-dimensional object 100 (see FIG. 3A) is finished. This three-dimensional object 100 has a desired three-dimensional shape, in which the reproducibility of the building position is kept throughout the layers.

### Effects of First Embodiment

As described above, the three-dimensional building apparatus 10 generates the three-dimensional object 100 formed of the photocurable model material 104 by removing the support member 122 formed of the photocurable support material 106 from the workpiece 120 obtained by successively depositing unit layers 131 to 134 including the model material 104 and/or the support material 106.

The three-dimensional building apparatus 10 includes [1] the stage 20 configured to hold the deposition structure 102 formed by depositing unit layers 131 to 134, [2] the ejection unit 32 configured to eject the model material 104 and the support material 106 toward the uppermost surface 108 of the deposition structure 102 while moving relative to the stage 20, [3] the emitting unit 38 configured to emit active beam light capable of curing the model material 104 and the support material 106, and [4] the heating unit 36 (heater) configured to heat the uppermost surface 108 of the deposition structure 102 in forming the workpiece 120.

The three-dimensional building method using the three-dimensional building apparatus 10 includes [1] an ejecting step (S42) of ejecting the model material 104 and the support material 106 toward the uppermost surface 108 of the deposition structure 102 formed by depositing the unit layers 131 to 134 while moving relative to the stage 20 configured to hold the deposition structure 102, [2] an emitting step (S45) of emitting active beam light capable of curing the model material 104 and the support material 106, and [3] a heating step (S44) of heating the uppermost surface 108 of the deposition structure 102 in forming the workpiece 120.

With this configuration, the uppermost surface 108 that is before being completely cured can directly and effectively be heated by emission of the active beam light. Thus, the three-dimensional object 100 with sufficient adhesion between the unit layers 131 to 134 can be generated even when a photocurable material having larger cure shrinkage due to photocuring placed under a low temperature condition is used as the model material 104 and the support material 106.

The heater according to the first embodiment is a warm air jetting part that jets warm air toward the uppermost surface 108 of the deposition structure 102. Jetting warm air enables contactless heating, so that the uppermost surface 108 is not roughened. Heating is particularly more effective when done after planarization (S43) of the uppermost surface 108.

### Second Embodiment

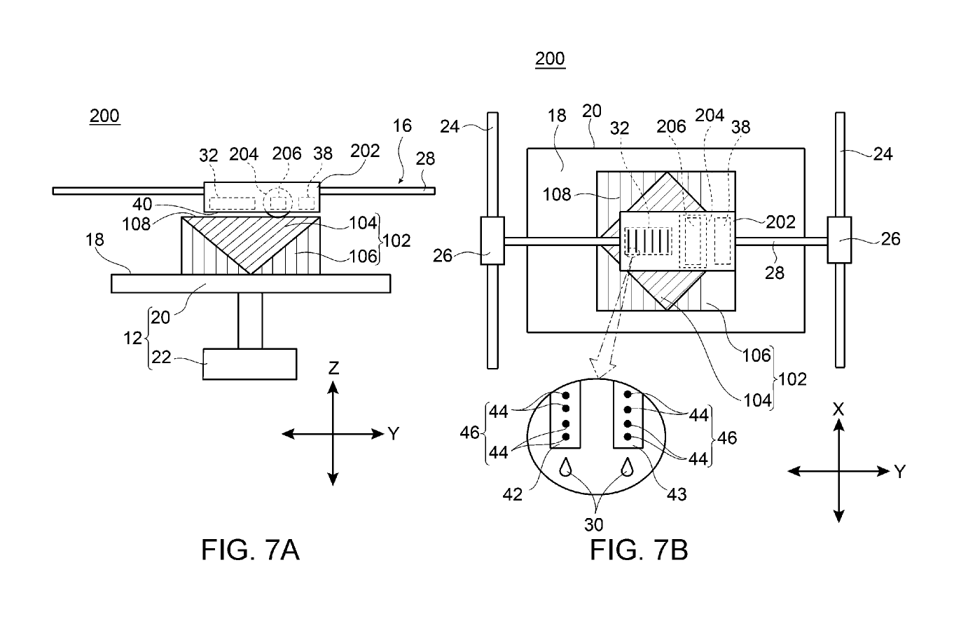

A three-dimensional building apparatus 200 according to a second embodiment will be described with reference to FIGS. 7A and 7B. Like numerals are assigned to the same configurations or functions as those of the three-dimensional building apparatus 10 according to the first embodiment, and explanation thereof may be omitted.

<Configuration and Operation of Three-Dimensional Building Apparatus 200>

FIGS. 7A and 7B are schematic diagrams illustrating the principal part of the three-dimensional building apparatus 200 according to the second embodiment. More specifically, FIG. 7A is a schematic side view of the three-dimensional building apparatus 200, and FIG. 7B is a schematic plan view of the three-dimensional building apparatus 200.

The three-dimensional building apparatus 200 includes a carriage 202 that has a configuration different from that in the first embodiment (carriage 14 in FIG. 1). Specifically, the carriage 202 is mounted with a planarizing roller 204 (planarizer, heater) that planarizes the uppermost surface 108 of the deposition structure 102, besides the ejection unit 32 and the emitting unit 38 described above. A built-in heater 206 capable of controlling temperature is provided to the inside of the planarizing roller 204.

Subsequently, the following describes operation of the three-dimensional building apparatus 200, specifically, operation for generating the three-dimensional object 100 illustrated in FIG. 3A. The three-dimensional building apparatus 200 basically operates in accordance with the flowchart in FIG. 4 except for building process at step S4.

In step S4 in FIG. 4, the three-dimensional building apparatus 200 generates the deposition structure 102 by successively depositing unit layers 131 to 134 including the model material 104 and the support material 106 along the Z direction while relatively moving the stage 20 and the ejection unit 32 in three-dimensional directions. The planarizing roller 204 contacts the uppermost surface 108 so as to transmit thermal energy from the built-in heater 206 to the uppermost surface 108 through the outer periphery of the planarizing roller 204.

That is, [1] designation of the unit layers 131 to 134 to be formed (S41), [2] ejection of droplets 30 using ejection unit 32 (S42), [3] planarization of the uppermost surface 108 (S43) and heating it (S44) using the planarizing roller 34, and [4] emitting UV using the emitting unit 38 (S45) are successively executed. The deposition structure 102 thus grows gradually along the vertical direction (the Z direction).

### Effects of Second Embodiment

As described above, the three-dimensional building apparatus 200 includes: [1] the stage 20; [2] the ejection unit 32; and [3] the emitting unit 38, and further includes: [4] the heater configured to heat the uppermost surface 108 of the deposition structure 102 in forming the workpiece 120; and [5] the planarizing roller 204 configured to contact the uppermost surface 108 while moving relative to the stage 20 so as to planarize the uppermost surface 108.

Even when this kind of configuration is employed, the three-dimensional object 100 with sufficient adhesion between the unit layers 131 to 134 can be generated similarly to the first embodiment. The heater according to the second embodiment is the planarizing roller 204 heated by the built-in heater 206 and can planarize (S43) and heat (S44) the uppermost surface 108 at the same time.

### Third Embodiment

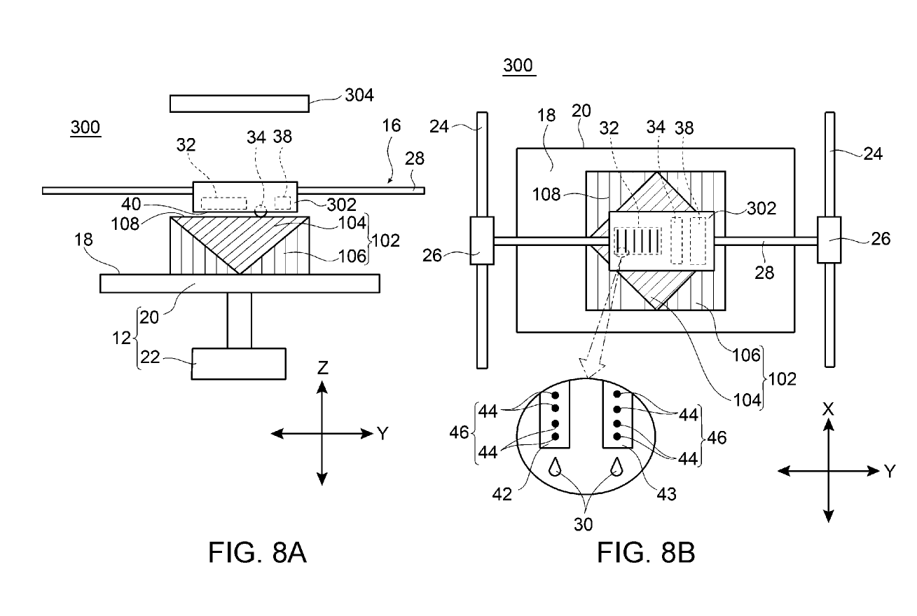

A three-dimensional building apparatus 300 according to a third embodiment will be described with reference to FIGS. 8A and 8B. Like numerals are assigned to the same configurations or functions as those of the three-dimensional building apparatus 10 according to the first embodiment, and explanation thereof may be omitted.

<Configuration and Operation of Three-Dimensional Building Apparatus 300>

FIGS. 8A and 8B are schematic diagrams illustrating the principal part of the three-dimensional building apparatus 300 according to the third embodiment. More specifically, FIG. 8A is a schematic side view of the three-dimensional building apparatus 300, and FIG. 8B is a schematic plan view of the three-dimensional building apparatus 300.

The three-dimensional building apparatus 300 includes a carriage 302 that has a configuration different from that in the first embodiment (carriage 14 in FIG. 1), and further includes an external heater 304 (heater) arranged facing the work surface 18 of the stage 20. This carriage 302 is mounted with only the ejection unit 32, the planarizing roller 34, and the emitting unit 38.

Subsequently, the following describes operation of the three-dimensional building apparatus 300, specifically, operation for generating the three-dimensional object 100 illustrated in FIG. 3A. The three-dimensional building apparatus 300 basically operates in accordance with the flowchart in FIG. 4 except for building process at step S4.

In step S4 in FIG. 4, the three-dimensional building apparatus 300 generates the deposition structure 102 by successively depositing the unit layers 131 to 134 including the model material 104 and the support material 106 along the Z direction while relatively moving the stage 20 and the ejection unit 32 in the three-dimensional directions. In other words, [1] designation of the unit layers 131 to 134 to be formed (S41), [2] ejection of droplets 30 using the ejection unit 32 (S42), [3] planarization of the uppermost surface 108 using the planarizing roller 34 (S43), and [4] emitting UV using the emitting unit 38 (S45) are successively executed. The deposition structure 102 thus grows gradually along the vertical direction (the Z direction).

At least during execution of building process, the heating controller 70 controls temperature so that the heating turns “ON” with respect to the external heater 304. Because the external heater 304 is arranged facing the deposition structure 102, thermal energy from the external heater 304 heats the uppermost surface 108.

### Effect of Third Embodiment

As described above, the three-dimensional building apparatus 300 includes: [1] the stage 20; [2] the ejection unit 32; and [3] the emitting unit 38, and further includes [4] the external heater 304 that is arranged facing the work surface 18 of the stage 20 and heats the uppermost surface 108 of the deposition structure 102 in forming the workpiece 120. Even when this kind of configuration is employed, the three-dimensional object with sufficient adhesion between the unit layers 131 to 134 can be generated similarly to the first embodiment.

[Remarks]

The present disclosure is not intended to be limited to the foregoing embodiments and can be modified as desired without departing from the scope of the disclosure, as a matter of course.

For example, although the first to third embodiments employ the configuration where the heating step (S44) is executed before the emitting step (S45), there is no restriction on the execution order of both processes if the heating step can be executed before the droplets 30 are completely cured. For example, when the droplets 30 are completely cured through the first and the second emitting steps, the adhesion improvement effect described above is obtained even when the first emitting step, the heating step, and the second emitting step are sequentially executed.

Although both the stage 20 and the ejection unit 32 are movable in the first to third embodiments, one may be fixed while the other may be movable, and three moving directions (the X direction, the Y direction, and the Z direction) may be combined as desired.

What is claimed is:

1. A three-dimensional building apparatus that generates a three-dimensional object formed of a photocurable model material, by removing a support member formed of a photocurable support material from a workpiece obtained by successively depositing unit layers including the photocurable model material and/or the photocurable support material, the three-dimensional building apparatus comprising:
a stage, configured to hold a deposition structure formed by depositing the unit layers;
an ejector, configured to eject the photocurable model material and the photocurable support material toward an uppermost surface of the deposition structure while moving relative to the stage;
an emitter, configured to emit an active beam light capable of curing the photocurable model material and the photocurable support material; and
a heater, configured to heat the uppermost surface of the deposition structure in forming the workpiece.

2. The three-dimensional building apparatus according to claim 1, wherein
the support member that is part of the workpiece includes a pedestal disposed between the three-dimensional object and the stage.

3. The three-dimensional building apparatus according to claim 1, wherein
the heater sequentially heats the uppermost surface on which ejection by the ejector and emission by the emitter are repeatedly performed.

4. The three-dimensional building apparatus according to claim 3, further comprising:
a heating controller that controls a temperature of the heater, so that the workpiece is heated at a higher temperature on a lower layer side, and the workpiece is heated at a lower temperature on an upper layer side.

5. The three-dimensional building apparatus according to claim 3, wherein
the heater is integrally with the ejector and is movable relative to the stage, and the three-dimensional building apparatus further comprising:
a heating controller, configured to control a temperature of the heater, so that a heating is temporarily prevented or stopped during the heater is at a position where the heater is unable to heat the uppermost surface.

6. The three-dimensional building apparatus according to claim 2, wherein
the heater sequentially heats the uppermost surface on which ejection by the ejector and emission by the emitter are repeatedly performed.

7. The three-dimensional building apparatus according to claim 1, wherein
the heater is a warm air jetting part that jets a warm air toward the uppermost surface.

8. The three-dimensional building apparatus according to claim 2, wherein
the heater is a warm air jetting part that jets a warm air toward the uppermost surface.

9. The three-dimensional building apparatus according to claim 3, wherein
the heater is a warm air jetting part that jets a warm air toward the uppermost surface.

10. The three-dimensional building apparatus according to claim 4, wherein
the heater is a warm air jetting part that jets a warm air toward the uppermost surface.

11. The three-dimensional building apparatus according to claim 5, wherein
the heater is a warm air jetting part that jets a warm air toward the uppermost surface.

12. The three-dimensional building apparatus according to claim 1, further comprising:
a planarizing roller that contacts the uppermost surface while moving relative to the stage so as to planarize the uppermost surface, wherein
the heater is the planarizing roller heated by a built-in heater.

13. The three-dimensional building apparatus according to claim 2, further comprising:
a planarizing roller that contacts the uppermost surface while moving relative to the stage so as to planarize the uppermost surface, wherein
the heater is the planarizing roller heated by a built-in heater.

14. The three-dimensional building apparatus according to claim 3, further comprising:
a planarizing roller that contacts the uppermost surface while moving relative to the stage so as to planarize the uppermost surface, wherein
the heater is the planarizing roller heated by a built-in heater.

15. The three-dimensional building apparatus according to claim 4, further comprising:
a planarizing roller that contacts the uppermost surface while moving relative to the stage so as to planarize the uppermost surface, wherein
the heater is the planarizing roller heated by a built-in heater.

16. The three-dimensional building apparatus according to claim 5, further comprising:
a planarizing roller that contacts the uppermost surface while moving relative to the stage so as to planarize the uppermost surface, wherein
the heater is the planarizing roller heated by a built-in heater.

17. A three-dimensional building method in which a three-dimensional object formed of a photocurable model material is generated by removing a support member formed of a photocurable support material from a workpiece obtained by successively depositing unit layers including the photocurable model material and/or the photocurable support material, the three-dimensional building method comprising:
an ejecting step of ejecting the photocurable model material and the photocurable support material toward an uppermost surface of a deposition structure formed by depositing the unit layers, while moving relative to a stage configured to hold the deposition structure;
an emitting step of emitting an active beam light capable of curing the photocurable model material and the photocurable support material; and
a heating step of heating the uppermost surface of the deposition structure in forming the workpiece.
